(19) United States
(12) Patent Application Publication
(10) Pub. No.: US 2025/0158244 A1
(43) Pub. Date: May 15, 2025

(54) ELECTRODE ASSEMBLY AND RECHARGEABLE BATTERY

(71) Applicant: SAMSUNG SDI CO., LTD., Yongin-si (KR)

(72) Inventors: Backgun KIM, Yongin-si (KR); Seungyeol YOO, Yongin-si (KR)

(21) Appl. No.: 18/887,965

(22) Filed: Sep. 17, 2024

(30) Foreign Application Priority Data
Nov. 9, 2023 (KR) 10-2023-0154812

(51) Int. Cl. H01M 50/533; H01M 10/04; H01M 50/103; H01M 50/15; H01M 50/46; H01M 50/474; H01M 50/477; H01M 50/536; H01M 50/538; H01M 50/55

(52) U.S. Cl. CPC H01M 50/533; H01M 10/0431; H01M 50/103; H01M 50/15; H01M 50/46; H01M 50/474; H01M 50/477; H01M 50/536; H01M 50/538; H01M 50/55

(57) ABSTRACT

An electrode assembly and a rechargeable battery are disclosed. An electrode assembly includes: a plurality of first electrode plates that include a plurality of first electrode tabs extending in a first direction and are stacked in a second direction crossing the first direction; a plurality of second electrode plates that include a plurality of second electrode tabs spaced apart from the plurality of first electrode tabs to extend in the first direction and are stacked in the second direction to cross the plurality of first electrode plates; and a separator that is located between each of the plurality of first electrode plates and each of the plurality of second electrode plates, and the plurality of first electrode tabs have a same first bending shape bent at least twice in the second direction.

### CROSS-REFERENCE TO RELATED APPLICATION

The present application claims priority to and the benefit of Korean Patent Application No. 10-2023-0154812, filed on Nov. 9, 2023 in the Korean Intellectual Property Office, the entire disclosure of which is incorporated herein by reference.

### BACKGROUND

### 1. Field

Aspects of embodiments of the present disclosure relate to an electrode assembly and a rechargeable battery including the same.

### 2. Description of the Related Art

In general, a rechargeable battery is a battery that may be charged and discharged.

A conventional rechargeable battery includes an electrode assembly in which a plurality of electrode plates including a plurality of electrode tabs are stacked, and a cap plate including a current collecting portion welded to the plurality of electrode tabs.

In the conventional rechargeable battery, an electrode plate includes the plurality of electrode tabs to prevent or substantially prevent a non-welding region from occurring between the plurality of electrode tabs and the current collecting portion.

### SUMMARY

According to an aspect of embodiments of the present disclosure, an electrode assembly with robust welding between a plurality of electrode tabs of a plurality of electrode plates of the electrode assembly and a current collecting portion of a cap plate, and a rechargeable battery including the same, are provided.

According to another aspect of embodiments of the present disclosure, an electrode assembly in which occurrence of a non-welding region between a plurality of electrode tabs of a plurality of electrode plates and a current collecting portion of a cap plate is suppressed even if one electrode plate included in the electrode assembly includes one electrode tab, and a rechargeable battery including the same, are provided.

According to another aspect of embodiments of the present disclosure, an electrode assembly in which a notching time and a notching cost for forming an electrode tab are reduced and, additionally, welding between a plurality of electrode tabs of a plurality of electrode plates and a current collecting portion of a cap plate is easily performed because one electrode plate included in the electrode assembly includes one electrode tab, and a rechargeable battery including the same, are provided.

According to one or more embodiments of the present disclosure, an electrode assembly includes: a plurality of first electrode plates that include a plurality of first electrode tabs extending in a first direction and are stacked in a second direction crossing the first direction; a plurality of second electrode plates that include a plurality of second electrode tabs spaced apart from the plurality of first electrode tabs to extend in the first direction and are stacked in the second direction to cross the plurality of first electrode plates; and a separator that is located between each of the plurality of first electrode plates and each of the plurality of second electrode plates, and the plurality of first electrode tabs have a same first bending shape bent at least twice in the second direction.

Each of the plurality of first electrode tabs may have the first bending shape, and the plurality of first electrode tabs may be overlapped in the second direction.

The plurality of second electrode tabs may have a same second bending shape bent at least twice in the second direction.

The second bending shape may be the same as the first bending shape.

Each of the plurality of second electrode tabs may have the second bending shape, and the plurality of second electrode tabs may be overlapped in the second direction.

The first bending shape may include a V-shape.

The first bending shape may include a Z-shape.

The first bending shape may include a curved shape.

The separator may include a plurality of separators located between each of the plurality of first electrode plates and each of the plurality of second electrode plates.

The separator may extend in a zigzag shape along a third direction crossing the first direction and the second direction to be located between each of the plurality of first electrode plates and each of the plurality of second electrode plates.

According to one or more embodiments of the present disclosure, a rechargeable battery includes: an electrode assembly; a case accommodating the electrode assembly therein; and a cap plate coupled to the case and electrically connected to the electrode assembly. The electrode assembly includes: a plurality of first electrode plates that include a plurality of first electrode tabs extending in a first direction to be connected to the cap plate and are stacked in a second direction crossing the first direction; a plurality of second electrode plates that include a plurality of second electrode tabs spaced apart from the plurality of first electrode tabs to extend in the first direction and be connected to the cap plate and are stacked in the second direction to cross the plurality of first electrode plates; and a separator that is located between each of the plurality of first electrode plates and each of the plurality of second electrode plates, and the plurality of first electrode tabs have a same first bending shape bent at least twice in the second direction.

Each of the plurality of first electrode tabs may have the first bending shape, and the plurality of first electrode tabs may be overlapped in the second direction.

The plurality of second electrode tabs may have a same second bending shape bent at least twice in the second direction.

The plurality of first electrode tabs may be located at a first end portion of the electrode assembly along the first direction, and the plurality of second electrode tabs may be located at a second end portion of the electrode assembly along the first direction.

The cap plate may be located at a third end portion of the electrode assembly along a third direction crossing the first direction and the second direction.

The cap plate may include: a main body covering the third end portion of the electrode assembly; a first current collecting portion extending from an end portion of the main body in the third direction to be welded with the plurality of first electrode tabs; and a second current collecting portion extending from another end portion of the main body in the third direction to be welded with the plurality of second electrode tabs.

The first current collecting portion and the plurality of first electrode tabs may be laser welded, and the second current collecting portion and the plurality of second electrode tabs may be laser welded.

The cap plate may further include: a first terminal located at the main body and connected to the first current collecting portion; and a second terminal located to be spaced apart from the first terminal at the main body and connected to the second current collecting portion.

The rechargeable battery may further include: a first tape supporting the first current collecting portion and the electrode assembly; and a second tape supporting the second current collecting portion and the electrode assembly.

The rechargeable battery may further include: a first side insulation between the first current collecting portion and the case; and a second side insulation between the second current collecting portion and the case.

According to the embodiments, an electrode assembly with robust welding between a plurality of electrode tabs of a plurality of electrode plates of the electrode assembly and a current collecting portion of a cap plate and a rechargeable battery including the same may be provided.

According to the embodiments, an electrode assembly in which occurrence of a non-welding region between a plurality of electrode tabs of a plurality of electrode plates and a current collecting portion of a cap plate is suppressed even if one electrode plate included in the electrode assembly includes one electrode tab and a rechargeable battery including the same may be provided.

According to the embodiments, an electrode assembly in which a notching time and a notching cost for forming an electrode tab are reduced and additionally welding between a plurality of electrode tabs of a plurality of electrode plates and a current collecting portion of a cap plate is easily performed because one electrode plate included in the electrode assembly includes one electrode tab and a rechargeable battery including the same may be provided.

### BRIEF DESCRIPTION OF THE DRAWINGS

FIG. 1 is a perspective view showing a rechargeable battery according to one or more embodiments.

FIG. 2 is a cross-sectional view taken along the line II-II of FIG. 1.

FIG. 3 is a cross-sectional view taken along the line III-III of FIG. 2.

FIG. 4 is a cross-sectional view showing another example of an electrode assembly of the rechargeable battery according to one or more embodiments.

FIG. 5 is a cross-sectional view showing an electrode assembly, a first current collecting portion, and a second current collecting portion of the rechargeable battery taken along the line V-V of FIG. 2.

FIG. 6 is a cross-sectional view showing an electrode assembly, a first current collecting portion, and a second current collecting portion of a rechargeable battery according to one or more embodiments.

FIG. 7 is a cross-sectional view showing an electrode assembly, a first current collecting portion, and a second current collecting portion of a rechargeable battery according to one or more embodiments.

DESCRIPTION OF SYMBOLS
electrode assembly 100;
first electrode plate 110;
first electrode tab 111;
second electrode plate 120;
second electrode tab 121;
separator 130;
first bending shape BT1;
second bending shape BT2

### DETAILED DESCRIPTION

Some example embodiments of the present disclosure will be described more fully herein with reference to the accompanying drawings so that those skilled in the art can easily implement the embodiments. However, the present disclosure may be modified in various different ways, all without departing from the spirit or scope of the present disclosure.

In addition, unless explicitly described to the contrary, the word “comprise” and variations such as “comprises” or “comprising” will be understood to imply the inclusion of stated elements but not the exclusion of any other elements.

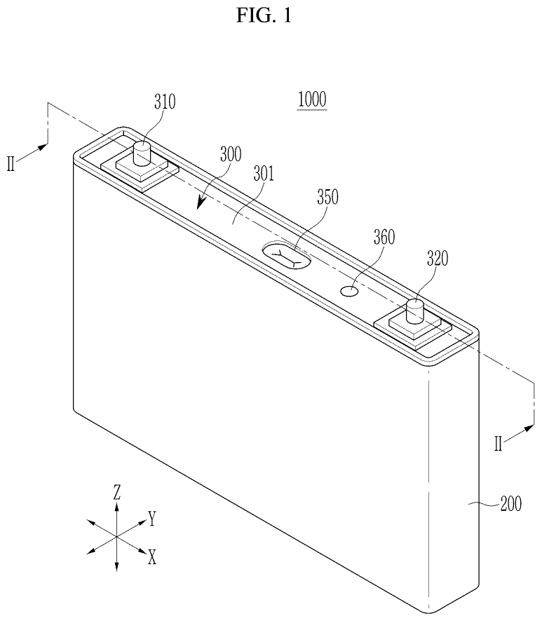

Herein, a rechargeable battery according to one or more embodiments will be described with reference to FIGS. 1 to 5.

The rechargeable battery according to one or more embodiments may include a quadrangle pillar-type rechargeable battery including a stacked electrode assembly in which electrode plates are stacked in a direction, but the present disclosure is not limited thereto, and the rechargeable battery may include a cylindrical, button-type, or pin-type rechargeable battery, for example.

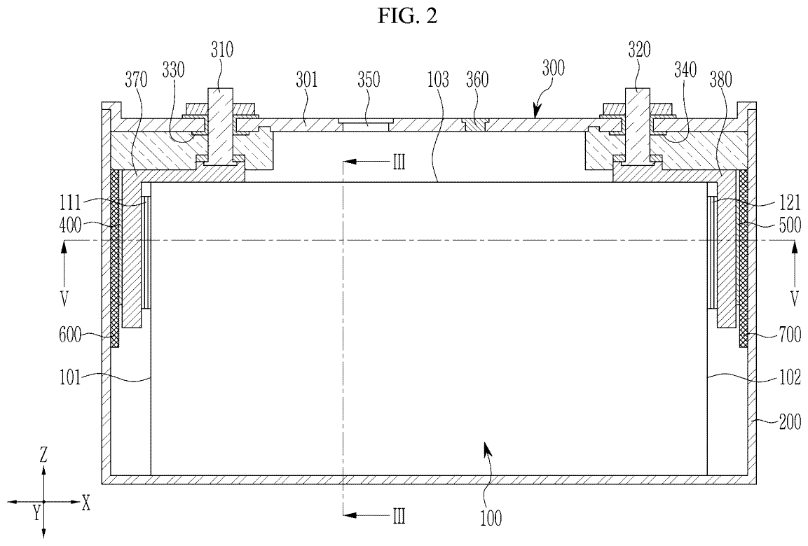

FIG. 1 is a perspective view showing a rechargeable battery according to one or more embodiments; and FIG. 2 is a cross-sectional view taken along the line II-II of FIG. 1.

Referring to FIG. 1 and FIG. 2, a rechargeable battery 1000 according to one or more embodiments may include an electrode assembly 100, a case 200, a cap plate 300, a first tape 400, a second tape 500, a first side insulation (or a first side insulation portion) 600, and a second side insulation (or a second side insulation portion) 700.

The electrode assembly 100 may be accommodated inside the case 200. The electrode assembly 100 may be sealed by the case 200 and the cap plate 300 coupled to each other.

A lower portion of the electrode assembly 100 may face a bottom portion of the case 200, and an upper portion of the electrode assembly 100 may face the cap plate 300 that covers an upper portion of the case 200. In an embodiment, the upper and lower portions of the electrode assembly 100 may have a planar shape parallel to each other, but the present disclosure is not limited thereto.

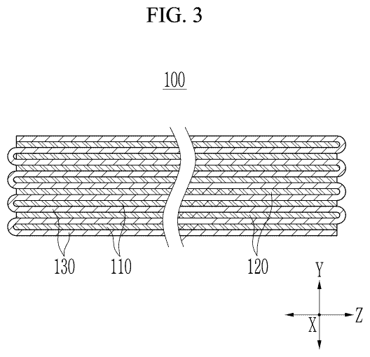

FIG. 3 is a cross-sectional view taken along the line III-III of FIG. 2.

Referring to FIG. 2 and FIG. 3, the electrode assembly 100 may include a plurality of first electrode plates 110, a plurality of second electrode plates 120, and a separator 130.

The plurality of first electrode plates 110 and the plurality of second electrode plates 120 may be spaced apart from each other, and the separator 130 including an insulating material may be disposed between each of the plurality of first electrode plates 110 and each of the plurality of second electrode plates 120. The plurality of first electrode plates 110 may be anodes (or negative electrodes), and the plurality of second electrode plates 120 may be cathodes (or positive electrodes), but the present disclosure is not limited thereto, and the plurality of first electrode plates may be cathodes, and the plurality of second electrode plates 120 may be anodes.

The plurality of first electrode plates 110 may have a plate shape extending in a first direction X and a third direction Z crossing the first direction X. The plurality of first electrode plates 110 may be stacked to be spaced apart from each other in a second direction Y crossing the first direction X and the third direction Z. Each of the plurality of first electrode plates 110 may include an anode coating portion that is a region in which an anode active material layer is applied to a current collector of a metal foil (e.g., a Cu foil), and an anode uncoated portion that is a region in which an active material layer is not applied. The anode uncoated portion may include a first electrode tab 111 of the first electrode plate 110. A plurality of first electrode tabs 111 of the plurality of first electrode plates 110 may be disposed at a first end portion 101 of the electrode assembly 100 that is an end portion of each of the plurality of first electrode plates 110 along the first direction X to extend in the first direction X. The plurality of first electrode tabs 111 may have a same first bending shape that is bent at least twice in the second direction Y. In an embodiment, the first electrode tab 111 may be integrated with the first electrode plate 110, but the present disclosure is not limited thereto, and the first electrode tab 111 may be connected to the first electrode plate 110.

The plurality of second electrode plates 120 may have a plate shape extending in the first direction X and the third direction Z crossing the first direction X.

The plurality of second electrode plates 120 may be stacked and spaced apart from each other in the second direction Y. The plurality of second electrode plates 120 may be stacked in the second direction Y to cross the plurality of first electrode plates 110, but the present disclosure is not limited thereto. Each of the plurality of second electrode plates 120 may be spaced apart from the plurality of first electrode plates with the separator 130 interposed therebetween such that the plurality of second electrode plates 120 are stacked in the second direction Y. Each of the plurality of second electrode plates 120 may include a cathode coating portion that is a region in which a cathode active material layer is applied to a current collector of a metal foil (e.g., an Al foil), and a cathode uncoated portion that is a region in which an active material layer is not applied. The cathode uncoated portion may include a second electrode tab 121 of the second electrode plate 120. A plurality of second electrode tabs 121 of the plurality of second electrode plates 120 may be spaced apart from the plurality of first electrode tabs 111 of the plurality of first electrode plates 110 in the first direction X so as to be disposed at a second end portion 102 of the electrode assembly that is an end portion of each of the plurality of second electrode plates 120 along the first direction X to extend in the first direction X. The plurality of second electrode tabs 121 may have a same second bending shape that is bent at least twice in the second direction Y. In an embodiment, the second electrode tab 121 may be integrated with the second electrode plate 120, but the present disclosure is not limited thereto, and the second electrode tab 121 may be connected to the second electrode plate 120.

The separator 130 may be disposed between the plurality of first electrode plates 110 and the plurality of second electrode plates 120. The separator 130 may prevent or substantially prevent a short circuit between each of the plurality of first electrode plates 110 and each of the plurality of second electrode plates 120. The separator 130 may extend in a zigzag shape in the third direction Z to be disposed between each of the plurality of first electrode plates 110 and each of the plurality of second electrode plates 120. In an embodiment, the separator 130 may have a Z-shape in which one separator 130 extends in a zigzag shape along the third direction Z, but the present disclosure is not limited thereto.

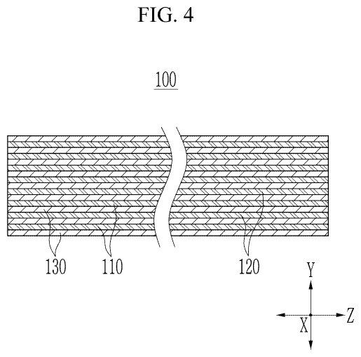

FIG. 4 is a cross-sectional view showing another example of the electrode assembly of the rechargeable battery according to one or more embodiments.

For example, referring to FIG. 4, the separator 130 may include a plurality of separators 130. The plurality of separators 130 may be disposed between each of the plurality of first electrode plates 110 and each of the plurality of second electrode plates 120, that is, between each of adjacent pairs of the first electrode plates 110 and the second electrode plates 120. Each of the plurality of separators 130 may be spaced apart from each other to be stacked in the second direction Y so as to be disposed between each of the plurality of first electrode plates 110 and each of the plurality of second electrode plates 120.

In an embodiment, referring to FIGS. 2 to 4, the plurality of first electrode plates 110, the separator 130, and the plurality of second electrode plates 120 may have a laminate shape sequentially stacked in the second direction Y, but the present disclosure is not limited thereto, and the plurality of first electrode plates 110, the separator 130, and the plurality of second electrode plates 120 may be wound in a jelly roll shape. Each of the plurality of first electrode plates 110, the plurality of second electrode plates 120, and the separator 130 may include any of various known materials.

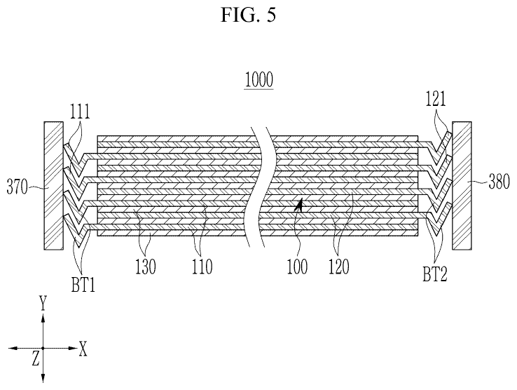

FIG. 5 is a cross-sectional view showing an electrode assembly, a first current collecting portion, and a second current collecting portion of the rechargeable battery taken along the line V-V of FIG. 2.

Referring to FIG. 5, the plurality of first electrode tabs 111 of the plurality of first electrode plates 110 may extend from the plurality of first electrode plates 110 in the first direction X. Each of the plurality of first electrode plates 110 may include one first electrode tab 111. The plurality of first electrode tabs 111 may have a same first bending shape BT1 bent at least twice in the second direction Y. In an embodiment, the first bending shape BT1 of each of the plurality of first electrode tabs 111 may include a V-shape, but the present disclosure is not limited thereto. In an embodiment, all of the plurality of first electrode tabs 111 may have the same first bending shape BT1, and may overlap each other in the second direction Y. In an embodiment, the plurality of first electrode tabs 111 may have the first bending shape BT1 by any of various known notching processes, but the present disclosure is not limited thereto. In an embodiment, the plurality of first electrode tabs 111 may be laser-welded with a first current collecting portion 370 of the cap plate 300. In an embodiment, the plurality of first electrode tabs 111 may be welded with the first current collecting portion 370 using a laser beam, but the present disclosure is not limited thereto, and the plurality of first electrode tabs 111 may be welded to the first current collecting portion 370 using any of various known welding means (or various known welding devices).

In a conventional rechargeable battery, in order to weld a plurality of electrode tabs of a plurality of electrode plates of an electrode assembly to a current collecting portion, a plurality of electrode tabs are formed to be bent in one direction, and then the plurality of electrode tabs bent are welded to the current collecting portion. Because some of the plurality of electrode tabs bent in the one direction pass over the current collecting portion in the one direction not to be welded with the current collecting portion, the plurality of other electrode tabs of the plurality of electrode plates adjacent to the plurality of electrode tabs of the plurality of electrode plates are formed to be bent in an opposite direction of the one direction, and then the bent plurality of other electrode tabs are welded to the collecting portion. Thus, in the conventional rechargeable battery, each of the plurality of electrode plates includes two electrode tabs to prevent or substantially prevent some of the plurality of electrode tabs from not being welded with the current collecting portion.

According to one or more embodiments of the present disclosure, each of the plurality of first electrode plates 110 of the electrode assembly 100 of the rechargeable battery 1000 includes one first electrode tab 111, and the plurality of first electrode tabs 111 may have the same first bending shape BT1 bent at least twice in the second direction Y to be overlapped in the second direction Y. Thus, because end portions of the plurality of first electrode tabs 111 are prevented or substantially prevented from passing over the first current collecting portion 370 in the second direction Y, welding between the plurality of first electrode tabs 111 of the plurality of first electrode plates 110 and the first current collecting portion 370 may be firmly performed.

Further, according to one or more embodiments of the present disclosure, even if each of the plurality of first electrode plates 110 of the electrode assembly 100 of the rechargeable battery 1000 includes the one first electrode tab 111, the plurality of first electrode tabs 111 may have the same first bending shape BT1 bent at least twice in the second direction Y to be overlapped in the second direction Y. Thus, because the end portions of the plurality of first electrode tabs 111 are prevented or substantially prevented from passing over the first current collecting portion 370 in the second direction Y, occurrence of a non-welding region between the plurality of first electrode tabs 111 of the plurality of first electrode plates 110 and the first current collecting portion 370 may be suppressed.

Further, according to one or more embodiments of the present disclosure, each of the plurality of first electrode plates 110 of the electrode assembly 100 of the rechargeable battery 1000 may include the one first electrode tab 111, and the plurality of first electrode tabs 111 may have the same first bending shape BT1 bent at least twice in the second direction Y to be overlapped in the second direction Y. Thus, because the end portions of the plurality of first electrode tabs 111 are prevented or substantially prevented from passing over the first current collecting portion 370 in the second direction Y, a notching time and a notching cost for forming one first electrode tab 111 of one first electrode plate 110 included in the electrode assembly 100 may be reduced, and, additionally, welding between the plurality of first electrode tabs 111 of the plurality of first electrode plates 110 and the first current collecting portion 370 may be easily performed.

The plurality of second electrode tabs 121 of the plurality of second electrode plates 120 may be spaced apart from the plurality of first electrode tabs 111 to extend from the plurality of second electrode plates 120 in the first direction X. Each of the plurality of second electrode plates 120 may include one second electrode tab 121. The plurality of second electrode tabs 121 may have a same second bending shape BT2 bent at least twice in the second direction Y. In an embodiment, the second bending shape BT2 of each of the plurality of second electrode tabs 121 may include a V-shape, but the present disclosure is not limited thereto. In an embodiment, the second bending shape BT2 of each of the plurality of second electrode tabs 121 may be the same as the first bending shape BT1 of each of the plurality of first electrode tabs 111, but the present disclosure is not limited thereto, and the second bending shape BT2 of each of the plurality of second electrode tabs 121 may be different from the first bending shape BT1 of each of the plurality of first electrode tabs 111. In an embodiment, all of the plurality of second electrode tabs 121 may have the same second bending shape BT2, and may overlap each other in the second direction Y. In an embodiment, the plurality of second electrode tabs 121 may have the second bending shape BT2 by various known notching processes, but the present disclosure is not limited thereto. The plurality of second electrode tabs 121 may be laser-welded with a second current collecting portion 380 of the cap plate 300. In an embodiment, the plurality of second electrode tabs 121 may be welded with the second current collecting portion 380 using a laser beam, but the present disclosure is not limited thereto, and the plurality of second electrode tabs 121 may be welded to the second current collecting portion 380 using any of various known welding means (or various known welding devices).

According to one or more embodiments of the present disclosure, each of the plurality of second electrode plates 120 of the electrode assembly 100 of the rechargeable battery 1000 may include one second electrode tab 121, and the plurality of second electrode tabs 121 may have the same second bending shape BT2 bent at least twice in the second direction Y to be overlapped in the second direction Y. Thus, because end portions of the plurality of second electrode tabs 121 are prevented or substantially prevented from passing over the second current collecting portion 380 in the second direction Y, welding between the plurality of second electrode tabs 121 of the plurality of second electrode plates 120 and the second current collecting portion may be firmly performed.

Further, according to one or more embodiments of the present disclosure, even if each of the plurality of second electrode plates 120 of the electrode assembly of the rechargeable battery 1000 includes the one second electrode tab 121, the plurality of second electrode tabs 121 may have the same second bending shape BT2 bent at least twice in the second direction Y to be overlapped in the second direction Y. Thus, because the end portions of the plurality of second electrode tabs 121 are prevented or substantially prevented from passing over the second current collecting portion 380 in the second direction Y, occurrence of a non-welding region between the plurality of second electrode tabs 121 of the plurality of second electrode plates 120 and the second current collecting portion 380 may be suppressed.

Further, according to one or more embodiments of the present disclosure, each of the plurality of second electrode plates 120 of the electrode assembly 100 of the rechargeable battery 1000 may include the one second electrode tab 121, and the plurality of second electrode tabs 121 may have the same second bending shape BT2 bent at least twice in the second direction Y to be overlapped in the second direction Y. Thus, because the end portions of the plurality of second electrode tabs 121 are prevented or substantially prevented from passing over the second current collecting portion 380 in the second direction Y, a notching time and a notching cost for forming one second electrode tab 121 of one second electrode plate 120 included in the electrode assembly 100 may be reduced, and, additionally, welding between the plurality of second electrode tabs 121 of the plurality of second electrode plates 120 and the second current collecting portion 380 may be easily performed.

Referring to FIG. 1 and FIG. 2, the electrode assembly 100 may be accommodated inside the case 200. In an embodiment, the case 200 may have a quadrangle pillar shape setting a space accommodating the electrode assembly 100 and an electrolyte therein, but the present disclosure is not limited thereto. An opening may be formed at an upper portion of the case 200, and the electrode assembly 100 may be inserted into the case 200 through the opening, but the present disclosure is not limited thereto. The case 200 may cover a lower portion of the electrode assembly 100, the first end portion 101 of the electrode assembly 100 along the first direction X, and the second end portion 102 of the electrode assembly 100 along the first direction X, but the present disclosure is not limited thereto.

The cap plate 300 may be coupled to the case 200, and may be electrically connected to the electrode assembly 100. The cap plate 300 may be coupled to the case 200 in a state in which the opening of the case 200 is covered, and may seal the inside of the case 200. In an embodiment, the cap plate 300 and the case 200 may include aluminum to be welded to each other, but the present disclosure is not limited thereto. The cap plate 300 may be disposed at a third end portion 103 that is an upper portion of the electrode assembly 100 in the third direction Z to cover the upper portion of the electrode assembly 100, but the present disclosure is not limited thereto.

In an embodiment, the cap plate 300 may include a main body 301, a first terminal 310, a second terminal 320, a first insulating portion 330, a second insulating portion 340, a vent portion 350, an electrolyte injection portion 360, the first current collecting portion 370, and the second current collecting portion 380.

The main body 301 may cover the third end portion 103 of the electrode assembly 100. In an embodiment, the main body 301 may include aluminum, but the present disclosure is not limited thereto, and the main body 301 may include any of various known materials.

The first terminal 310 may be disposed at the main body 301, and may be connected to the first current collecting portion 370. The first terminal 310 may have a same polarity as that of a first electrode plate of the electrode assembly 100.

The second terminal 320 may be spaced apart from the first terminal 310 to be disposed at the main body 301. The second terminal 320 may be connected to the second current collecting portion 380. The second terminal 320 may have a same polarity as that of a second electrode plate of the electrode assembly 100.

The first insulating portion 330 may insulate between the main body 301 and the first terminal 310. The first insulating portion 330 may include a gasket, but the present disclosure is not limited thereto, and the first insulating portion 330 may include any of various known insulating means (or various known insulating devices).

The second insulating portion 340 may insulate between the main body 301 and the second terminal 320. The second insulating portion 340 may include a gasket, but the present disclosure is not limited thereto, and the second insulating portion 340 may include any of various known insulating means (or various known insulating devices).

The vent portion 350 may be disposed at the main body 301, and may include any of various known vent means (or various known vent devices) capable of discharging an internal pressure of the rechargeable battery 1000.

The electrolyte injection portion 360 may be disposed at the main body 301, and may include any of various known electrolyte injection means (or various known electrolyte injection devices) that may inject an electrolyte into the case 200. For example, the electrolyte injection portion 360 may couple the cap plate 300 to the case in which the electrode assembly 100 is accommodated, and then may serve as a path capable of injecting the electrolyte into the case 200. After the electrolyte is injected, the electrolyte injection portion 360 may be sealed by any of various known sealing means (or various known sealing devices).

The first current collecting portion 370 may extend in the third direction Z from the first terminal 310 disposed at an end portion of the main body 301 to be laser-welded with the plurality of first electrode tabs 111 of the plurality of first electrode plates of the electrode assembly 100. The first current collecting portion 370 may be welded with the plurality of first electrode tabs 111 disposed at the first end portion 101 of the electrode assembly 100 along the first direction X. The first current collecting portion 370 may have any of various known shapes extending from the cap plate 300 to the plurality of first electrode tabs 111 of the electrode assembly 100.

The second current collecting portion 380 may extend in the third direction Z from the second terminal 320 disposed at another end portion of the main body 301, and may be laser-welded with the plurality of second electrode tabs 121 of the plurality of second electrode plates of the electrode assembly 100. The second current collecting portion 380 may be welded with the plurality of second electrode tabs 121 disposed at the second end portion 102 of the electrode assembly 100 along the first direction X. The second current collecting portion 380 may have any of various known shapes extending from the cap plate 300 to the plurality of second electrode tabs 121 of the electrode assembly 100.

The first tape 400 may support the first current collecting portion 370 and the electrode assembly 100 together. The first tape 400 may be attached to one or more (e.g., some) surfaces of the first current collecting portion 370 and some surfaces of the electrode assembly 100 to support the first current collecting portion 370 and the electrode assembly 100, but the present disclosure is not limited thereto, and the first tape 400 may include any of various known insulating tapes.

The second tape 500 may support the second current collecting portion 380 and the electrode assembly 100 together. The second tape 500 may be attached to one or more (e.g., some) surfaces of the second current collecting portion 380 and some surfaces of the electrode assembly 100 to support the second current collecting portion 380 and the electrode assembly 100, but the present disclosure is not limited thereto, and the second tape 500 may include any of various known insulating tapes.

The first side insulation 600 may be disposed between the first current collecting portion 370 and the case 200. The first side insulation 600 may prevent or substantially prevent the first current collecting portion 370 and the case 200 from being in contact with each other. The first side insulation 600 may include any of various known insulating means (or various known insulating devices).

The second side insulation 700 may be disposed between the second current collecting portion 380 and the case 200. The second side insulation 700 may prevent or substantially prevent the second current collecting portion 380 and the case from being in contact with each other. The second side insulation 700 may include any of various known insulating means (or various known insulating devices).

According to one or more embodiments of the present disclosure, each of the plurality of first electrode plates 110 of the electrode assembly 100 of the rechargeable battery 1000 may include the one first electrode tab 111, each of the plurality of second electrode plates 120 may include the one second electrode tab 121, the plurality of first electrode tabs 111 may have the same first bending shape BT1 bent at least twice in the second direction Y to be overlapped in the second direction Y, and the plurality of second electrode tabs 121 may have the same second bending shape BT2 bent at least twice in the second direction Y to be overlapped in the second direction Y. Thus, because the end portions of the plurality of first electrode tabs 111 are prevented or substantially prevented from passing over the first current collecting portion 370 in the second direction Y and the end portions of the plurality of second electrode tabs 121 are prevented or substantially prevented from passing over the second current collecting portion 380 in the second direction Y, welding between the plurality of first electrode tabs 111 of the plurality of first electrode plates 110 and the first current collecting portion 370 may be firmly performed, and, additionally, welding between the plurality of second electrode tabs 121 of the plurality of second electrode plates 120 and the second current collecting portion 380 may be firmly performed.

Further, according to one or more embodiments of the present disclosure, each of the plurality of first electrode plates 110 of the electrode assembly 100 of the rechargeable battery 1000 may include the one first electrode tab 111, and even if each of the plurality of second electrode plates 120 includes the one second electrode tab 121, the plurality of first electrode tabs 111 may have the same first bending shape BT1 bent at least twice in the second direction Y to be overlapped in the second direction Y, and the plurality of second electrode tabs 121 may have the same second bending shape BT2 bent at least twice in the second direction Y to be overlapped in the second direction Y. Thus, because the end portions of the plurality of first electrode tabs 111 are prevented or substantially prevented from passing over the first current collecting portion 370 in the second direction Y and the end portions of the plurality of second electrode tabs 121 are prevented or substantially prevented from passing over the second current collecting portion 380 in the second direction Y, occurrence of a non-welding region between the plurality of first electrode tabs 111 of the plurality of first electrode plates 110 and the first current collecting portion 370 may be suppressed, and, additionally, occurrence of a non-welding region between the plurality of second electrode tabs 121 of the plurality of second electrode plates 120 and the second current collecting portion 380 may be suppressed.

Further, according to one or more embodiments of the present disclosure, each of the plurality of first electrode plates 110 of the electrode assembly 100 of the rechargeable battery 1000 according to the embodiments may include the one first electrode tab 111, each of the plurality of second electrode plates 120 may include the one second electrode tab 121, the plurality of first electrode tabs 111 may have the same first bending shape BT1 bent at least twice in the second direction Y to be overlapped in the second direction Y, and the plurality of second electrode tabs 121 may have the same second bending shape BT2 bent at least twice in the second direction Y to be overlapped in the second direction Y. Thus, because the end portions of the plurality of first electrode tabs 111 are prevented or substantially prevented from passing over the first current collecting portion 370 in the second direction Y and the end portions of the plurality of second electrode tabs 121 are prevented or substantially prevented from passing over the second current collecting portion 380 in the second direction Y, a notching time and a notching cost for forming one first electrode tab 111 of one first electrode plate 110 included in the electrode assembly 100 may be reduced and welding between the plurality of first electrode tabs 111 of the plurality of first electrode plates 110 and the first current collecting portion 370 may be easily performed, and, additionally, a notching time and a notching cost for forming one second electrode tab 121 of one second electrode plate 120 may be reduced and welding between the plurality of second electrode tabs 121 of the plurality of second electrode plates 120 and the second current collecting portion 380 may be easily performed.

According to one or more embodiments, the electrode assembly 100 with robust welding between the plurality of electrode tabs of the plurality of electrode plates of the electrode assembly 100 and the current collecting portion of the cap plate 300, and the rechargeable battery 1000 including the same, may be provided.

Further, according to one or more embodiments, the electrode assembly 100 in which occurrence of a non-welding region between the plurality of electrode tabs of the plurality of electrode plates and the current collecting portion of the cap plate 300 is suppressed even if one electrode plate included in the electrode assembly 100 includes one electrode tab, and the rechargeable battery 1000 including the same, may be provided.

Further, according to one or more embodiments, the electrode assembly 100 in which a notching time and a notching cost for forming the electrode tab are reduced and, additionally, welding between the plurality of electrode tabs of the plurality of electrode plates and the current collecting portion of the cap plate 300 is easily performed because one electrode plate included in the electrode assembly 100 includes one electrode tab, and the rechargeable battery 1000 including the same, may be provided.

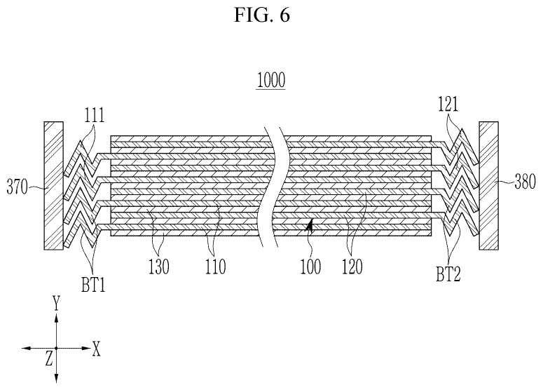

Herein, a rechargeable battery according to one or more embodiments will be described with reference to FIG. 6.

Herein, a portion of one or more embodiments different from the rechargeable battery according to the embodiments described above will be described.

FIG. 6 is a cross-sectional view showing an electrode assembly, a first current collecting portion, and a second current collecting portion of the rechargeable battery according to one or more embodiments.

Referring to FIG. 6, the plurality of first electrode tabs 111 of the plurality of first electrode plates 110 of the rechargeable battery 1000 according to one or more embodiments may extend from the plurality of first electrode plates 110 in the first direction X. Each of the plurality of first electrode plates 110 may include one first electrode tab 111. The plurality of first electrode tabs 111 may have the same first bending shape BT1 bent at least three times in the second direction Y. In an embodiment, the first bending shape BT1 of each of the plurality of first electrode tabs may include a Z-shape, but the present disclosure is not limited thereto. In an embodiment, all of the plurality of first electrode tabs 111 may have the same first bending shape BT1, and may overlap each other in the second direction Y. In an embodiment, the plurality of first electrode tabs 111 may have the first bending shape BT1 by any of various known notching processes, but the present disclosure is not limited thereto. In an embodiment, the plurality of first electrode tabs 111 may be laser-welded with the first current collecting portion 370 of the cap plate 300. In an embodiment, the plurality of first electrode tabs 111 may be welded with the first current collecting portion 370 using a laser beam, but the present disclosure is not limited thereto, and the plurality of first electrode tabs 111 may be welded to the first current collecting portion 370 using any of various known welding means (or various known welding devices).

The plurality of second electrode tabs 121 of the plurality of second electrode plates 120 may be spaced apart from the plurality of first electrode tabs 111 to extend from the plurality of second electrode plates 120 in the first direction X. Each of the plurality of second electrode plates 120 may include one second electrode tab 121. The plurality of second electrode tabs 121 may have the same second bending shape BT2 bent at least three times in the second direction Y. In an embodiment, the second bending shape BT2 of each of the plurality of second electrode tabs 121 may include a Z-shape, but the present disclosure is not limited thereto. In an embodiment, the second bending shape BT2 of each of the plurality of second electrode tabs 121 may be the same as the first bending shape BT1 of each of the plurality of first electrode tabs 111, but the present disclosure is not limited thereto, and the second bending shape BT2 of each of the plurality of second electrode tabs 121 may be different from the first bending shape BT1 of each of the plurality of first electrode tabs 111. In an embodiment, all of the plurality of second electrode tabs 121 may have the same second bending shape BT2, and may overlap each other in the second direction Y. In an embodiment, the plurality of second electrode tabs 121 may have the second bending shape BT2 by any of various known notching processes, but the present disclosure is not limited thereto. In an embodiment, the plurality of second electrode tabs 121 may be laser-welded with the second current collecting portion 380 of the cap plate 300. In an embodiment, the plurality of second electrode tabs 121 may be welded with the second current collecting portion 380 using a laser beam, but the present disclosure is not limited thereto, and the plurality of second electrode tabs 121 may be welded to the second current collecting portion 380 using any of various known welding means (or various known welding devices).

According to one or more embodiments, each of the plurality of first electrode plates 110 of the electrode assembly 100 of the rechargeable battery 1000 may include the one first electrode tab 111, each of the plurality of second electrode plates 120 may include the one second electrode tab 121, the plurality of first electrode tabs 111 may have the same first bending shape BT1 bent at least three times in the second direction Y to be overlapped in the second direction Y, and the plurality of second electrode tabs 121 may have the same second bending shape BT2 bent at least three times in the second direction Y to be overlapped in the second direction Y. Thus, because the end portions of the plurality of first electrode tabs 111 are prevented or substantially prevented from passing over the first current collecting portion 370 in the second direction Y and the end portions of the plurality of second electrode tabs are prevented or substantially prevented from passing over the second current collecting portion 380 in the second direction Y, welding between the plurality of first electrode tabs 111 of the plurality of first electrode plates 110 and the first current collecting portion 370 may be firmly performed, and, additionally, welding between the plurality of second electrode tabs 121 of the plurality of second electrode plates 120 and the second current collecting portion 380 may be firmly performed.

Further, according to one or more embodiments, each of the plurality of first electrode plates 110 of the electrode assembly 100 of the rechargeable battery 1000 may include the one first electrode tab 111, and even if each of the plurality of second electrode plates 120 includes the one second electrode tab 121, the plurality of first electrode tabs 111 may have the same first bending shape BT1 bent at least three times in the second direction Y to be overlapped in the second direction Y, and the plurality of second electrode tabs 121 may have the same second bending shape BT2 bent at least three times in the second direction Y to be overlapped in the second direction Y. Thus, because the end portions of the plurality of first electrode tabs 111 are prevented or substantially prevented from passing over the first current collecting portion 370 in the second direction Y and the end portions of the plurality of second electrode tabs 121 are prevented or substantially prevented from passing over the second current collecting portion 380 in the second direction Y, occurrence of a non-welding region between the plurality of first electrode tabs 111 of the plurality of first electrode plates 110 and the first current collecting portion 370 may be suppressed, and, additionally, occurrence of a non-welding region between the plurality of second electrode tabs 121 of the plurality of second electrode plates 120 and the second current collecting portion 380 may be suppressed.

Further, according to one or more embodiments, each of the plurality of first electrode plates 110 of the electrode assembly 100 of the rechargeable battery 1000 may include the one first electrode tab 111, each of the plurality of second electrode plates 120 may include the one second electrode tab 121, the plurality of first electrode tabs 111 may have the same first bending shape BT1 bent at least three times in the second direction Y to be overlapped in the second direction Y, and the plurality of second electrode tabs 121 may have the same second bending shape BT2 bent at least three times in the second direction Y to be overlapped in the second direction Y. Thus, because the end portions of the plurality of first electrode tabs 111 are prevented or substantially prevented from passing over the first current collecting portion 370 in the second direction Y and the end portions of the plurality of second electrode tabs are prevented or substantially prevented from passing over the second current collecting portion 380 in the second direction Y, a notching time and a notching cost for forming one first electrode tab 111 of one first electrode plate 110 included in the electrode assembly 100 may be reduced and welding between the plurality of first electrode tabs 111 of the plurality of first electrode plates 110 and the first current collecting portion 370 may be easily performed, and, additionally, a notching time and a notching cost for forming one second electrode tab 121 of one second electrode plate 120 may be reduced and welding between the plurality of second electrode tabs of the plurality of second electrode plates 120 and the second current collecting portion 380 may be easily performed.

According to one or more embodiments, the electrode assembly 100 with robust welding between the plurality of electrode tabs of the plurality of electrode plates of the electrode assembly 100 and the current collecting portion of the cap plate 300, and the rechargeable battery 1000 including the same, may be provided.

Further, according to one or more embodiments, the electrode assembly 100 in which occurrence of a non-welding region between the plurality of electrode tabs of the plurality of electrode plates and the current collecting portion of the cap plate 300 is suppressed even if one electrode plate included in the electrode assembly 100 includes one electrode tab, and the rechargeable battery 1000 including the same, may be provided.

Further, according to one or more embodiments, the electrode assembly 100 in which a notching time and a notching cost for forming the electrode tab are reduced and, additionally, welding between the plurality of electrode tabs of the plurality of electrode plates and the current collecting portion of the cap plate 300 is easily performed because one electrode plate included in the electrode assembly 100 includes one electrode tab, and the rechargeable battery 1000 including the same, may be provided.

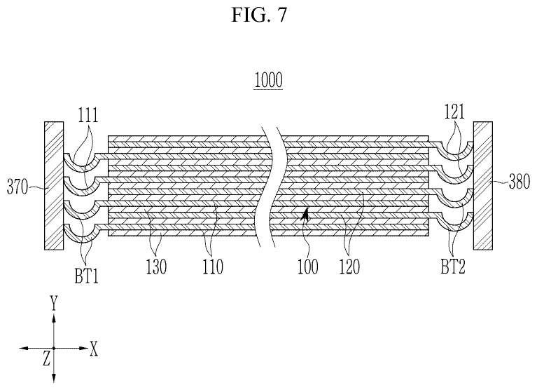

Herein, a rechargeable battery according to one or more embodiments will be described with reference to FIG. 7.

Herein, a portion of one or more embodiments different from the rechargeable battery according to the embodiments described above will be described.

FIG. 7 is a cross-sectional view showing an electrode assembly, a first current collecting portion, and a second current collecting portion of the rechargeable battery according to one or more embodiments.

Referring to FIG. 7, the plurality of first electrode tabs 111 of the plurality of first electrode plates 110 of the rechargeable battery 1000 according to one or more embodiments may extend from the plurality of first electrode plates 110 in the first direction X. Each of the plurality of first electrode plates 110 may include one first electrode tab 111. The plurality of first electrode tabs 111 may have the same first bending shape BT1 bent at least twice in the second direction Y. In an embodiment, the first bending shape BT1 of each of the plurality of first electrode tabs 111 may include a curved shape, but the present disclosure is not limited thereto. In an embodiment, all of the plurality of first electrode tabs 111 may have the same first bending shape BT1, and may overlap each other in the second direction Y. In an embodiment, the plurality of first electrode tabs 111 may have the first bending shape BT1 by any of various known notching processes, but the present disclosure is not limited thereto. In an embodiment, the plurality of first electrode tabs 111 may be laser-welded with the first current collecting portion 370 of the cap plate 300. In an embodiment, the plurality of first electrode tabs 111 may be welded with the first current collecting portion 370 using a laser beam, but the present disclosure is not limited thereto, and the plurality of first electrode tabs 111 may be welded to the first current collecting portion 370 using any of various known welding means (or various known welding devices).

The plurality of second electrode tabs 121 of the plurality of second electrode plates 120 may be spaced apart from the plurality of first electrode tabs 111 to extend from the plurality of second electrode plates 120 in the first direction X. Each of the plurality of second electrode plates 120 may include one second electrode tab 121. The plurality of second electrode tabs 121 may have the same second bending shape BT2 bent at least twice in the second direction Y. In an embodiment, the second bending shape BT2 of each of the plurality of second electrode tabs 121 may include a curved shape, but the present disclosure is not limited thereto. In an embodiment, the second bending shape BT2 of each of the plurality of second electrode tabs 121 may be the same as the first bending shape BT1 of each of the plurality of first electrode tabs 111, but the present disclosure is not limited thereto, and the second bending shape BT2 of each of the plurality of second electrode tabs 121 may be different from the first bending shape BT1 of each of the plurality of first electrode tabs 111. In an embodiment, all of the plurality of second electrode tabs 121 may have the same second bending shape BT2, and may overlap each other in the second direction Y. In an embodiment, the plurality of second electrode tabs 121 may have the second bending shape BT2 by any of various known notching processes, but the present disclosure is not limited thereto. In an embodiment, the plurality of second electrode tabs 121 may be laser-welded with the second current collecting portion 380 of the cap plate 300. In an embodiment, the plurality of second electrode tabs 121 may be welded with the second current collecting portion 380 using a laser beam, but the present disclosure is not limited thereto, and the plurality of second electrode tabs may be welded to the second current collecting portion 380 using any of various known welding means (or various known welding devices).

According to one or more embodiments, each of the plurality of first electrode plates 110 of the electrode assembly 100 of the rechargeable battery 1000 may include the one first electrode tab 111, each of the plurality of second electrode plates 120 may include the one second electrode tab 121, the plurality of first electrode tabs 111 may have the same first bending shape BT1 bent at least twice in the second direction Y to be overlapped in the second direction Y, and the plurality of second electrode tabs 121 may have the same second bending shape BT2 bent at least twice in the second direction Y to be overlapped in the second direction Y. Thus, because the end portions of the plurality of first electrode tabs 111 are prevented or substantially prevented from passing over the first current collecting portion 370 in the second direction Y and the end portions of the plurality of second electrode tabs 121 are prevented or substantially prevented from passing over the second current collecting portion 380 in the second direction Y, welding between the plurality of first electrode tabs 111 of the plurality of first electrode plates 110 and the first current collecting portion 370 may be firmly performed, and, additionally, welding between the plurality of second electrode tabs 121 of the plurality of second electrode plates 120 and the second current collecting portion 380 may be firmly performed.

Further, according to one or more embodiments, each of the plurality of first electrode plates 110 of the electrode assembly 100 of the rechargeable battery 1000 may include the one first electrode tab 111, and even if each of the plurality of second electrode plates 120 includes the one second electrode tab 121, the plurality of first electrode tabs 111 may have the same first bending shape BT1 bent at least twice in the second direction Y to be overlapped in the second direction Y, and the plurality of second electrode tabs 121 may have the same second bending shape BT2 bent at least twice in the second direction Y to be overlapped in the second direction Y. Thus, because the end portions of the plurality of first electrode tabs 111 are prevented or substantially prevented from passing over the first current collecting portion 370 in the second direction Y and the end portions of the plurality of second electrode tabs 121 are prevented or substantially prevented from passing over the second current collecting portion 380 in the second direction Y, occurrence of a non-welding region between the plurality of first electrode tabs 111 of the plurality of first electrode plates and the first current collecting portion 370 may be suppressed, and, additionally, occurrence of a non-welding region between the plurality of second electrode tabs 121 of the plurality of second electrode plates 120 and the second current collecting portion may be suppressed.

Further, according to one or more embodiments, each of the plurality of first electrode plates 110 of the electrode assembly 100 of the rechargeable battery 1000 may include the one first electrode tab 111, each of the plurality of second electrode plates 120 may include the one second electrode tab 121, the plurality of first electrode tabs 111 may have the same first bending shape BT1 bent at least twice in the second direction Y to be overlapped in the second direction Y, and the plurality of second electrode tabs 121 may have the same second bending shape BT2 bent at least twice in the second direction Y to be overlapped in the second direction Y. Thus, because the end portions of the plurality of first electrode tabs 111 are prevented or substantially prevented from passing over the first current collecting portion 370 in the second direction Y and the end portions of the plurality of second electrode tabs 121 are prevented or substantially prevented from passing over the second current collecting portion 380 in the second direction Y, a notching time and a notching cost for forming one first electrode tab 111 of one first electrode plate 110 included in the electrode assembly 100 may be reduced and welding between the plurality of first electrode tabs 111 of the plurality of first electrode plates 110 and the first current collecting portion 370 may be easily performed, and, additionally, a notching time and a notching cost for forming one second electrode tab 121 of one second electrode plate 120 may be reduced and welding between the plurality of second electrode tabs of the plurality of second electrode plates 120 and the second current collecting portion 380 may be easily performed.

According to one or more embodiments, the electrode assembly 100 with robust welding between the plurality of electrode tabs of the plurality of electrode plates of the electrode assembly 100 and the current collecting portion of the cap plate 300 and the rechargeable battery 1000 including the same may be provided.

Further, according to one or more embodiments, the electrode assembly 100 in which occurrence of a non-welding region between the plurality of electrode tabs of the plurality of electrode plates and the current collecting portion of the cap plate 300 is suppressed even if one electrode plate included in the electrode assembly 100 includes one electrode tab, and the rechargeable battery 1000 including the same, may be provided.

Further, according to one or more embodiments, the electrode assembly 100 in which a notching time and a notching cost for forming the electrode tab are reduced and, additionally, welding between the plurality of electrode tabs of the plurality of electrode plates and the current collecting portion of the cap plate 300 is easily performed because one electrode plate included in the electrode assembly 100 includes one electrode tab, and the rechargeable battery 1000 including the same, may be provided.

While the present disclosure has been described in connection with what are presently considered to be some practical embodiments, it is to be understood that the disclosure is not limited to the disclosed embodiments, but, on the contrary, is intended to cover various modifications and equivalent arrangements included within the spirit and scope of the claims.

What is claimed is:

1. An electrode assembly comprising:
a plurality of first electrode plates that comprise a plurality of first electrode tabs extending in a first direction and are stacked in a second direction crossing the first direction;
a plurality of second electrode plates that comprise a plurality of second electrode tabs spaced apart from the plurality of first electrode tabs to extend in the first direction and are stacked in the second direction to cross the plurality of first electrode plates; and
a separator that is located between each of the plurality of first electrode plates and each of the plurality of second electrode plates,
wherein the plurality of first electrode tabs have a same first bending shape bent at least twice in the second direction.

2. The electrode assembly as claimed in claim 1, wherein each of the plurality of first electrode tabs has the first bending shape, and the plurality of first electrode tabs are overlapped in the second direction.

3. The electrode assembly as claimed in claim 1, wherein the plurality of second electrode tabs have a same second bending shape bent at least twice in the second direction.

4. The electrode assembly as claimed in claim 3, wherein the second bending shape is the same as the first bending shape.

5. The electrode assembly as claimed in claim 3, wherein each of the plurality of second electrode tabs has the second bending shape, and the plurality of second electrode tabs are overlapped in the second direction.

6. The electrode assembly as claimed in claim 1, wherein the first bending shape comprises a V-shape.

7. The electrode assembly as claimed in claim 1, wherein the first bending shape comprises a Z-shape.

8. The electrode assembly as claimed in claim 1, wherein the first bending shape comprises a curved shape.

9. The electrode assembly as claimed in claim 1, wherein the separator comprises a plurality of separators located between each of the plurality of first electrode plates and each of the plurality of second electrode plates.

10. The electrode assembly as claimed in claim 1, wherein the separator extends in a zigzag shape along a third direction crossing the first direction and the second direction to be located between each of the plurality of first electrode plates and each of the plurality of second electrode plates.

11. A rechargeable battery comprising:
an electrode assembly;
a case accommodating the electrode assembly therein; and
a cap plate coupled to the case and electrically connected to the electrode assembly,
wherein the electrode assembly comprises: a plurality of first electrode plates that comprise a plurality of first electrode tabs extending in a first direction to be connected to the cap plate and are stacked in a second direction crossing the first direction; a plurality of second electrode plates that comprise a plurality of second electrode tabs spaced apart from the plurality of first electrode tabs to extend in the first direction and be connected to the cap plate and are stacked in the second direction to cross the plurality of first electrode plates; and a separator that is located between each of the plurality of first electrode plates and each of the plurality of second electrode plates, and the plurality of first electrode tabs have a same first bending shape bent at least twice in the second direction.

12. The rechargeable battery as claimed in claim 11, wherein each of the plurality of first electrode tabs has the first bending shape, and the plurality of first electrode tabs are overlapped in the second direction.

13. The rechargeable battery as claimed in claim 11, wherein the plurality of second electrode tabs have the same second bending shape bent at least twice in the second direction.

14. The rechargeable battery as claimed in claim 11, wherein the plurality of first electrode tabs are located at a first end portion of the electrode assembly along the first direction, and the plurality of second electrode tabs are disposed at a second end portion of the electrode assembly along the first direction.

15. The rechargeable battery as claimed in claim 14, wherein the cap plate is located at a third end portion of the electrode assembly along a third direction crossing the first direction and the second direction.

16. The rechargeable battery as claimed in claim 15, wherein the cap plate comprises:
a main body covering the third end portion of the electrode assembly;
a first current collecting portion extending from an end portion of the main body in the third direction to be welded with the plurality of first electrode tabs; and
a second current collecting portion extending from another end portion of the main body in the third direction to be welded with the plurality of second electrode tabs.

17. The rechargeable battery as claimed in claim 16, wherein the first current collecting portion and the plurality of first electrode tabs are laser welded, and the second current collecting portion and the plurality of second electrode tabs are laser welded.

18. The rechargeable battery as claimed in claim 16, wherein the cap plate further comprises:
a first terminal located at the main body and connected to the first current collecting portion; and
a second terminal located to be spaced apart from the first terminal at the main body and connected to the second current collecting portion.

19. The rechargeable battery as claimed in claim 16, further comprising:
a first tape supporting the first current collecting portion and the electrode assembly; and
a second tape supporting the second current collecting portion and the electrode assembly.

20. The rechargeable battery as claimed in claim 16, further comprising:
a first side insulation between the first current collecting portion and the case; and
a second side insulation between the second current collecting portion and the case.
